(19) United States
(12) Patent Application Publication
(10) Pub. No.: US 2025/0043571 A1
(43) Pub. Date: Feb. 6, 2025

(54) SELF-SUPPORTING ELEMENT FOR THE CONSTRUCTION OF STRUCTURES AND ASSOCIATED METHOD OF REALIZATION

(71) Applicant: ETESIAS S.R.L., Napoli (IT)

(72) Inventors: Andrea FRAGNITO, Benevento (IT); Costantino MENNA, Napoli (IT); Gerardo Maria MAURO, Benevento (IT); Marcello IASIELLO, Napoli (IT)

(73) Assignee: ETESIAS S.R.L., Napoli (IT)

(21) Appl. No.: 18/709,131

(22) PCT Filed: Nov. 10, 2022
(86) PCT No.: PCT/IB2022/060826

§ 371 Date: May 10, 2024

(30) Foreign Application Priority Data
Nov. 11, 2021 (IT) 102021000028745

(51) Int. Cl. E04C 2/04; B28B 1/00; B33Y 10/00; B33Y 80/00; C04B 14/04; C04B 18/167; C04B 28/00; C04B 103/00; C04B 103/30; C04B 111/00; C04B 111/40

(52) U.S. Cl. CPC E04C 2/044; B28B 1/001; B33Y 10/00; B33Y 80/00; C04B 14/048; C04B 18/167; C04B 28/00; C04B 2103/0079; C04B 2103/30; C04B 2111/00181; C04B 2111/40

(57) ABSTRACT

The present disclosure relates to a self-supporting element (1) for the construction of structures, comprising a first and a second side wall (2, 3) wherein at least one between the first and the second side wall (2, 3) is made of cementitious material. The first and the second side wall (2, 3) are positioned in a predetermined positional relationship and are separated from each other by an air volume (4). According to the invention, the element (1) comprises at least one dividing partition (5), placed between the first and the second side wall (2, 3). The dividing partition (5) has a curved profile at least partially doubled and is configured to mitigate the thermal convection within the air volume (4). The present invention further relates to the method of manufacturing the element (1).

### FIELD OF TECHNIQUE

The present disclosure refers to the sector of construction elements and in particular concerns a self-supporting element for the construction of structures, characterized by low thermal transmittance.

The present disclosure also relates to a method of manufacturing said self-supporting element.

### PRIOR ART

Energy transition represents a global challenge that every country is called to face in order to safeguard the earth's ecosystem.

This process is now essential due to the uncontrolled rise of greenhouse gas emissions, linked to all sectors, by way of example and not as a limitation, residential, industrial and tertiary.

In particular, the residential sector is configured as one of the most energy-consuming and therefore responsible for a substantial portion of the total pollutants and climate-altering substances emitted into the atmosphere. This consumption is largely linked to the inefficient energy design of the building stock.

One of the main causes of energy inefficiencies is the poor design of the building envelope, responsible for substantial heat losses/returns, and consequently increased thermal loads. These loads, to be balanced by appropriate air conditioning systems, are therefore likely to lead to considerable energy consumption.

Today, electricity production on a global scale still relies to a large extent on the exploitation of fossil fuels, and thus non-renewable sources. For this reason, the inefficiency of each element of the building complex can be a non-negligible cause of pollution and climate change.

In this context, there are currently measures aimed at the redevelopment of buildings, in particular of buildings for residential use, which in most cases see as the leading intervention the installation of thermal coats, which are insulation layers aimed at increasing the thermal resistance of the opaque envelope.

On the contrary, for new constructions, a thermal analysis of the building is planned during the design step, aimed at complying with the regulations and minimum requirements in force in relation to energy performance. Despite this, various studies have highlighted the criticalities of current construction techniques. The current critical issues include first and foremost the costs of materials and labor, underlining the need to revisit and reform the processes leading to the construction of a building.

The publicly accessible DM 26/6/2015 provides an example of a regulatory requirement for the construction of buildings in Italy; the details of this DM are therefore not reported here.

Having said this, one can understand the reasons why there is currently great interest in researching new techniques for the design and construction of the building envelope. In this scenario, “Additive Manufacturing”, i.e. the set of techniques for the production of objects starting from computerized 3D models, plays a leading role.

Increasingly stringent regulations pose constraints that represent a challenge also for innovative production techniques such as 3D printing. In detail, among the most complex there is the improvement of thermal performance, which translates into the reduction of thermal transmittance U, representing the indicator of the thermal power exchanged per surface unit and temperature difference, below fixed limit values as the climatic zone varies.

The solutions for reducing the thermal power transmitted through molded walls have so far been inspired by those currently used to improve the performance of the building envelope.

Patent application US2009/0193749A1 relates to a structural element made of fiber-reinforced cementitious material, having a configuration capable of conferring considerable resistance, while being of limited weight. This structural element is presented as a monolithic panel, comprising a pair of frontal components, a pair of side components, a pair of terminal components and a plurality of connection components extending diagonally within the panel between the two frontal components. The connecting components are planar, rectangular-shaped components that may have triangular-shaped notches in order to make the panel lighter. This structural element is obtained by pouring a liquid mixture of fiber-reinforced concrete around a matrix in light insulating material, which, once poured, is left in place in order to make the structure acoustically and thermally insulating.

The scientific article “Mix design and fresh properties for high-performance printing concrete” by TT Le, S. A. Austin, S. Lim, R. A. Buswell, A. G. F. Gibb, T. Thorpe, published in Materials and Structures (2012), Kluwer Academic Publishers, volume 45, pages 1221-1232, concerns a fiber-reinforced cement mixture with workability and extrudability characteristics that make the mixture particularly suitable for use in additive printing processes. A bench made by molding this mixture is also described, the mixture being otherwise usable to make further architectural components, for example cladding and wall panels.

Further documents belonging to the state of the art are the patent application EP3421201A1 and the U.S. Pat. No. 5,644,887.

### Objectives of the Invention

The purpose of the present disclosure is to describe an element for the construction of structures which allows solving the drawbacks of the known art.

The purpose of the present disclosure is to describe a method for manufacturing the element for the construction of structures capable of overcoming the drawbacks of the known art.

It is a further object of the present invention to describe a self-supporting element for the construction of structures which, while maintaining adequate structural strength, achieves a significant reduction of thermal transmittance, particularly when subjected to a temperature gradient in the direction of its thickness.

It is a further object of the present invention to describe a self-supporting element which has a structure suitable to mitigate the heat transmission through it, said heat transmission being due to conduction and/or convection and/or radiation.

It is a further object of the present invention to obtain an optimization in the energy efficiency of structures such as residential buildings, by means of a simple and economical method for the construction of self-supporting elements, this construction method being moreover flexible so that it can be adapted to different regulatory contexts.

These and further objects are achieved by the element for the construction of structures and by the method for manufacturing said element, which will be described hereinafter in their salient aspects. These aspects can be combined with each other, just as the features in the following claims can be combined with any of the following aspects included in the description.

### DESCRIPTION OF THE FIGURES

The invention will now be described in some embodiments with reference to the accompanying Figures. A brief description of the Figures is provided below.

FIG. 1 illustrates a perspective view of a first embodiment of an element for the construction of structures according to the present disclosure.

FIG. 2 illustrates a sectional view of the element of FIG. 1.

FIG. 3 illustrates an exploded view of the element of FIG. 1.

FIG. 4 illustrates a flowchart relating to a method of construction of structures according to the present disclosure.

FIG. 5 illustrates a diagram showing an air velocity field in empty volumes defined within the element of FIG. 1, with a temperature differential of 10° C.

FIG. 6 illustrates a diagram showing an iso-velocity and air direction range in empty volumes defined within the element of FIG. 1, with a temperature differential of 10° C.

FIG. 7 illustrates a diagram showing a temperature range in the element in accordance with the present disclosure.

### DETAILED DESCRIPTION OF THE INVENTION

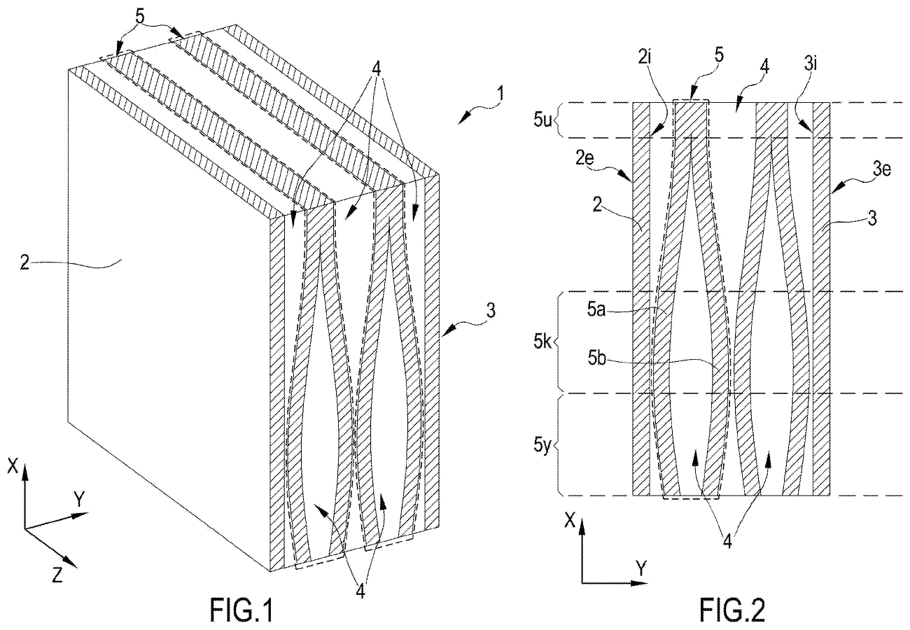

With reference to FIG. 1, the reference number 1 indicates an element for the construction of structures as a whole.

The element 1 is configured to be modularly employed together with other elements 1 to create structures including, but not limited to, buildings for residential use. In particular, the element 1, which will be described hereinafter, can be juxtaposed, placed side by side or superimposed on one or more further elements 1, considered individually or in a plurality. In particular, by means of a plurality of elements 1 it is possible to define a wall or a covering of a wall of a structure, in particular of a building. This wall can conveniently comprise a traditional reinforced concrete and/or brick structure.

It is also noted that the element 1 is self-supporting, which means that said element 1 does not require any additional external elements to maintain its shape.

In order to facilitate the understanding of the structure of the invention, the description of the element 1 will refer to a first axis X, a second axis Y orthogonal to the first axis X and a third axis Z, orthogonal both to the first axis X and to the second axis Y. The element 1 is preferably configured to be oriented in such a way that the first axis X represents a vertical axis.

The element 1 is configured to be manufactured by 3D printing or, equivalently, by additive manufacturing.

Additive manufacturing offers countless advantages over traditional manufacturing techniques. The ability to make the complexity of the shapes a value (currently a limitation) and to ensure the uniformity of the materials (leaving their properties unchanged at each point), the reduction in the number of production steps and the lowering of costs are among the privileges of this technology.

In particular, the teachings set forth in the European Patent EP3487673B1 and in the Italian Patent IT102019000006300 may be used for the realisation of element 1, teachings which are incorporated herein for reference.

In detail, as it will become clear from the detailed description that follows, the advantage obtained from the application of a layer of insulation placed externally to element 1 has been studied. The insertion of loose material within the air cavities formed between the layers of cement mortar has been investigated. In detail, these cavities tend to be filled with the aim of creating barriers to heat transfer. Advantageously, the element 1 described herein is specifically configured and designed to be made in a single process through a single material.

The element 1 described herein contributes to improved thermal performances by acting on the geometric configuration of its inner layers.

In the course of the present description, reference will be made to thermal transmittance values. According to the UNI EN ISO 6946 standard, the thermal transmittance U [W/m²K] is given by the reciprocal of the sum of the specific thermal resistances [m²K/W]. In detail, this sum consists of four terms: the internal laminar resistance Rsi and external laminar resistance Rse, the resistance of the non-homogeneous layers Rnh and the resistance referred to the layers of homogeneous material Rh. The internal laminar resistance Rsi and external laminar resistance Rse are equal to the reciprocal of the convective conductance of the air, the resistance referred to the layers of homogeneous material Rh is equal to the ratio between the thickness of the material and its thermal conductivity, while the resistance of the non-homogeneous layers Rnh can be obtained by simulating the behavior of the fluid. The transmittance therefore varies considerably depending on the environmental conditions, which are taken into account by evaluating the internal laminar resistances Rsi and external laminar resistance Rse. These internal laminar resistances Rsi and external laminar resistance Rse are to be evaluated in accordance with what is reported in the UNI EN ISO 6946 standard. If, on the other hand, the heat transfer relative to the wall alone is to be analysed, it is necessary to refer to the thermal conductance C. For non-homogeneous elements, such as for example those with non-uniform thermal properties such as, by way of example and not as a limitation, air cavities, reference must be made to the thermal conductance C of the layer, expressed in W/m²K. The conductance values are reported in the appropriate reference standards including UNI EN ISO 6946 or can be obtained by means of laboratory tests or numerical simulations with finite elements.

Through the conductance C it is therefore possible to disengage from considering the interaction between element 1 and the external conditions (variable depending on the location) and to take into account only the thermal performance of element 1. The values obtained for the conductance C and the transmittance U of element 1, in a particular embodiment characterized by the presence of low-emissivity paints and thermal-insulating paints, are equal to 0.355 W/m²K and 0.335 W/m²K respectively. More generally, the element 1 is configured and specifically adapted to have a thermal conductance C substantially equal to or less than 0.48 W/m²K, more preferably equal to or less than 0.43 W/m²K and even more preferably equal to or less than 0.38 W/m²K and/or to have a thermal transmittance T substantially equal to or less than 0.45 W/m²K, more preferably equal to or less than 0.4 W/m²K and even more preferably equal to or less than 0.35 W/m² K.

In a specific and non-limiting embodiment, the thermal conductance C differs from the thermal transmittance U due to the liminal air resistances (internal and external). In particular, in this embodiment, the value of the thermal conductance C is slightly higher than that of the thermal transmittance U. By way of non-limiting examples, the Applicant has devised three specific embodiments for the element 1 described herein, wherein U=0.45 W/m²K and C=0.48 W/m²K, or wherein U=0.4 W/m²K and C=0.43 W/m²K, or wherein U=0.35 W/m²K and C=0.38 W/m²K.

FIG. 1 illustrates a perspective view of a non-limiting embodiment of the element 1 disclosed herein. The embodiment of FIG. 1 has two dividing partitions 5 juxtaposed to each other along a direction substantially parallel to the second axis Y or, equivalently put side by side on two X-Y planes. The number of two dividing partitions 5 should not be considered as limiting.

The element 1 comprises a first side wall 2 (or first panel 2) and a second side wall 3 (or second panel 3). In the non-limiting embodiment of FIG. 1, the first side wall 2 and the second side wall 3 are each positioned on a plane parallel to the XZ plane and are therefore parallel, resulting in a predetermined positional relationship. The first side wall 2 and the second side wall 3 constitute external walls of the element 1.

The element 1 comprises at least one dividing partition 5 interposed between the first and second side walls 2, 3. The dividing partition 5 has a particular curved profile configured to improve the thermal performance of the element 1, in particular in relation to the thermal convection of the element 1. The curved profile of the dividing partition 5 determines that the distance, measured along the second axis Y, which separates the first and/or second side walls 2, 3 with respect to the dividing partition 5 varies according to the portion of the area of the dividing partition 5 considered.

As can be observed from FIG. 1 and in particular from the section of FIG. 2, the curved profile of the at least one dividing partition 5 is at least partially doubled and/or at least partially split and essentially not in contact with the first and second side walls 2, 3; in fact a thin air volume 4 is present between the dividing partition 5 and the first and second side walls 2, 3.

In more detail, the specific and non-limiting embodiment of the element 1 of FIG. 1 and of FIG. 2 comprises a first side wall 2 (on the left) and a second side wall 3 (on the right). The first and the second side walls 2, 3 each comprise a respective external face 2e, 3e and a respective internal face 2i, 3i. Between the first and the second side walls 2, 3 a first dividing partition 5 and a second dividing partition 5 are present. Each of the two dividing partitions has a curved profile at least partially doubled and/or at least partially split. The dividing partition 5 on the left is substantially separated from the first side wall 2; the dividing partition 5 on the left is also substantially separated from the dividing partition 5 on the right. The dividing partition 5 on the right is substantially separated from the second side wall 3.

Although a substantially smooth external face 2e of the first side wall 2 is observed in FIG. 2, this configuration is not to be intended as limiting; in fact, the external face 2e of the first side wall 2 can also have a substantially, or at least partially, textured configuration; the external face 2e can also be configured to support designs of various kinds. The above is also valid, in combination or alternatively, for the external face 3e of the second side wall 3. The texturing determines the presence of slight incisions or reliefs, which can follow a random or predefined pattern.

Each of the two dividing partitions 5 comprises a first intermediate wall 5a and a second intermediate wall 5b; each of the first and second intermediate walls 5a, 5b comprises a first face and a second face. The second face is substantially opposite to the first face. According to the present invention, the first face is the one oriented towards the left, while the second face is the one oriented towards the right.

Each of the two dividing partitions 5 comprises an upper end portion and a lower end portion. The upper end portion and the lower end portion are substantially aligned along the first axis X.

In a preferred but non-limiting embodiment, the first and the second intermediate walls 5a, 5b are substantially in contact with each other in correspondence of the upper end portion and are substantially separated along the lower end portion. An intermediate portion is present between the upper end portion and the lower end portion; also in this intermediate portion the first and the second intermediate side walls 5a, 5b are separated from each other.

In correspondence of the lower end portion and in correspondence of the intermediate portion there is an air volume 4 between the first and the second intermediate walls 5a, 5b. Within the scope of the present invention, embodiments can also be contemplated wherein the volume defined between the first and the second intermediate walls 5a, 5b is made airtight by means of specific measures. In this case, gases having lower thermal conductivity values than air can be injected into the volume defined between the first and the second intermediate wall 5a, or a vacuum can be created, so that a pressure lower than the atmospheric pressure exists within the volume defined between the first and the second intermediate walls 5a, 5b.

In the non-limiting embodiment of FIG. 2 it is possible to observe that in correspondence of the intermediate portion the distance locally assumed between the first and the second intermediate walls 5a, 5b is substantially greater than the distance locally assumed between the first and second intermediate walls 5a, 5b in correspondence with the lower end portion. The aforementioned distance is measured along the second axis Y. Preferably, but not limitedly, the distance locally assumed between the first and the second intermediate walls 5a, 5b in correspondence of the intermediate portion is substantially a maximum distance reached between the first and the second intermediate walls 5a, 5b.

Preferably, but not limitedly, the curved profile is a profile with sinusoids substantially specular with respect to each other and more generally it is a curved profile without angular points. In particular, computer tools were used to define the optimal curved profile assumed by the first and the second intermediate walls 5a, 5b. These computer tools provide, in one embodiment, the use of genetic algorithms particularly effective in the management of curved profiles without angular points for fluid dynamics analysis.

Furthermore, the maximum inclination of the curved profile with respect to the vertical plane is such that it does not exceed a maximum inclination beyond which the realization of the dividing partition 5 by 3D printing would become critical, said maximum inclination depending on the viscosity of the cement mortar used.

The particular sinusoidal profile conformation of the first and of the second intermediate walls is such that in correspondence of the intermediate portion, the first and the second intermediate walls 5a, 5b each have a convexity facing outwards of the dividing partition 5. In correspondence of the lower end portion, the first and the second intermediate walls 5a, 5b can each have a flexure that identifies a concavity when viewed from the outside of the dividing partition 5.

In FIG. 2 it is clearly visible that in correspondence of the intermediate portion, the distance separating the second intermediate wall 5b of the dividing partition 5 on the left from the first intermediate wall 5a of the dividing partition 5 on the right is minimal and in any case smaller than the distance separating the second intermediate wall 5b of the dividing partition 5 on the left from the first intermediate wall 5a of the dividing partition 5 on the right in correspondence of the lower end portion and/or in correspondence of the upper end portion. Preferably, the distance separating the second intermediate wall 5b of the dividing partition 5 on the left from the first intermediate wall 5a of the dividing partition 5 on the right in correspondence of the upper end portion is maximum.

Although the embodiment of the invention illustrated in FIGS. 1 and 2 is to be considered a preferred embodiment, since it allows obtaining cavities within the element 1 which serve as housing cavities for air pockets, the Applicant intends to specify that numerous similarly advantageous alternative embodiments are also possible. For example, instead of the specular sinusoidal profiles, rhomboidal profiles or honeycomb profiles can be used for the dividing partition 5, as these profiles are similarly suitable for accommodating air pockets.

In order to ensure the portability of the element 1, a perimeter frame (not shown in the Figures) can be applied to it, which can possibly be removed prior to the installation of the element 1.

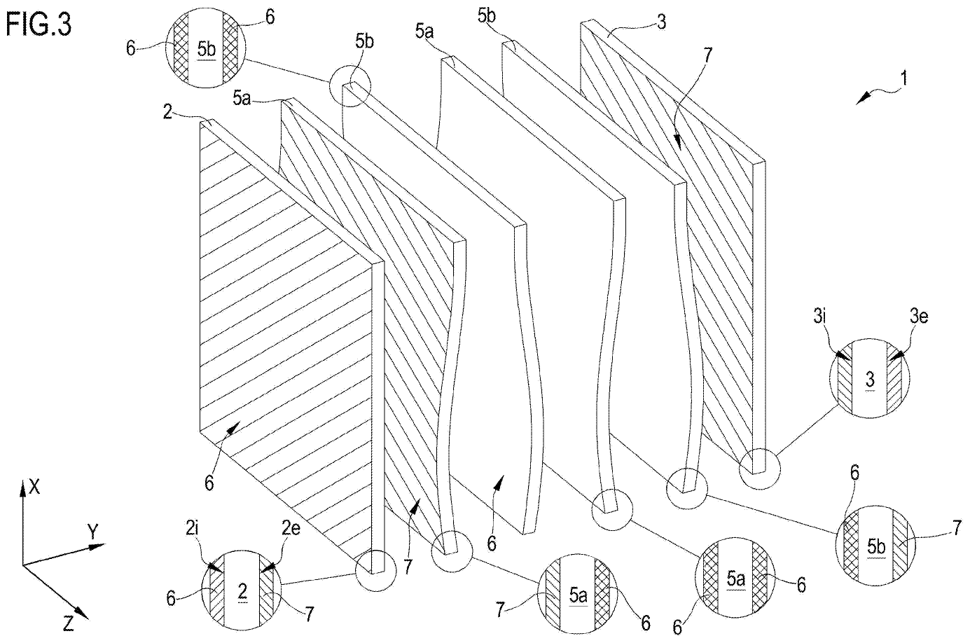

FIG. 3 illustrates a perspective view of the element 1 according to the present disclosure wherein, in order to increase the thermal performance of the element 1, auxiliary layers apt to reduce the thermal transmittance of the element 1 are provided on the first and on the second side walls 2, 3 and on the first and on the second intermediate side walls 5a, 5b of each of the left and right dividing partitions 5.

In detail, the external face 2e of the first side wall 2 has a layer of thermal-insulating material 6. In particular, said layer of thermal-insulating material 6 comprises thermal-insulating paint. Preferably, but not limitedly, the thermal-insulating paint comprises glassy material, and even more preferably it comprises hollow glass microspheres. The purpose of the thermal-insulating material, in particular of the thermal-insulating paint, is to reduce the heat conduction of the first side wall 2 towards the outside of the element 1.

The inner face 2i of the first side wall 2 has a layer of low-emissivity material 7. In particular, said layer of low-emissivity material 7 comprises low-emissivity paint. Preferably, but not limitedly, the low-emissivity paint comprises an aluminum-based material. The purpose of the low-emissivity material, in particular of the low-emissivity paint, is to reduce the heat radiation of the first side wall 2 towards the inside of the element 1. The layer of low-emissivity material 7 can be present in alternative to the layer of thermal-insulating material 6, or together with the layer of thermal-insulating material 6 as in the case of FIG. 3.

In the dividing partition 5 on the left, the first face of the first intermediate wall 5a has a layer of low-emissivity material 7. In particular, this layer of low-emissivity material 7 comprises low-emissivity paint. Preferably, but not limitedly, the low-emissivity paint comprises an aluminum-based material. The purpose of the low-emissivity material, in particular of the low-emissivity paint, is to reduce the heat radiation of the first intermediate wall 5a towards the internal face 2i of the first side wall 2.

In the dividing partition 5 on the left, the second face of the first intermediate wall 5a has a layer of thermal-insulating material 6, preferably comprising thermal-insulating paint. Preferably, but not limitedly, the thermal-insulating paint comprises glassy material, and even more preferably it comprises hollow glass microspheres. The purpose of the thermal-insulating material, in particular of the thermal-insulating paint, is to reduce the heat conduction of the first intermediate wall 5a towards the air volume 4 and towards the second intermediate wall 5b of the dividing partition 5 on the left.

On the first intermediate wall 5a of the dividing partition 5 on the left, the layer of thermal-insulating material 6 and the layer of low-emissivity material 7 can be either both or alternatively present.

In the dividing partition 5 on the left, the first face and the second face of the second intermediate wall 5b each have a layer of thermal-insulating material 6, preferably comprising thermal-insulating paint. Preferably, but not limitedly, the thermal-insulating paint comprises glassy material, and even more preferably it comprises hollow glass microspheres. The purpose of the thermal-insulating material, in particular of the thermal-insulating paint, is to reduce the heat conduction of the second intermediate wall 5b. The layer of thermal-insulating material 6 can be present on both faces of the second intermediate wall 5b or on only one between the first and second faces of the second intermediate wall 5b.

In the dividing partition 5 on the right, the first face and the second face of the first intermediate wall 5a each have a layer of thermal-insulating material 6, preferably comprising thermal-insulating paint. Preferably, but not limitedly, the thermal-insulating paint comprises glassy material, and even more preferably it comprises hollow glass microspheres. The purpose of the thermal-insulating material, in particular of the thermal-insulating paint, is to reduce the heat conduction of the first intermediate wall 5a. The layer of thermal-insulating material 6 can be present on both faces of the first intermediate wall 5a or on only one between the first or second face of the first intermediate wall 5a.

In the dividing partition 5 on the right, the first face of the second intermediate wall 5b has a layer of thermal-insulating material 6, preferably comprising thermal-insulating paint. Preferably, but not limitedly, the thermal-insulating paint comprises glassy material, and even more preferably it comprises hollow glass microspheres. The purpose of the thermal-insulating material, in particular of the thermal-insulating paint, is to reduce the heat conduction of the first intermediate wall 5a towards the air volume 4 and towards the first intermediate wall 5a of the dividing partition 5 on the right.

In the dividing partition 5 on the right, the second face of the second intermediate wall 5b has a layer of low-emissivity material 7. In particular, this layer of low-emissivity material 7 comprises low-emissivity paint. Preferably, but not limitedly, the low-emissivity paint comprises an aluminum-based material. The purpose of the low-emissivity material, in particular of the low-emissivity paint, is to reduce the heat radiation of the second intermediate wall 5b towards the inner face 3i of the second side wall 3.

On the second intermediate wall 5b of the dividing partition 5 on the right, the layer of thermal-insulating material 6 and the layer of low-emissivity material 7 can be either both or alternatively present.

The internal face 3i of the second side wall 3 has a layer of low-emissivity material 7. In particular, this layer of low-emissivity material 7 comprises low-emissivity paint. Preferably, but not limitedly, the low-emissivity paint comprises an aluminum-based material. The purpose of the low-emissivity material, in particular of the low-emissivity paint, is to reduce the heat radiation of the second side wall 3 towards the inside of the element 1.

Finally, the external face 3e of the second side wall 3 has a layer of thermal-insulating material 6. In particular, this layer of thermal-insulating material 6 comprises thermal-insulating paint. Preferably, but not limitedly, the thermal-insulating paint comprises glassy material, and even more preferably it comprises hollow glass microspheres. The purpose of the thermal-insulating material, in particular of the thermal-insulating paint, is to reduce the heat conduction of the second side wall 3 towards the outside of the element 1.

The layer of low-emissivity material 7 can be present as an alternative to the layer of thermal-insulating material 6, or together with the layer of thermal-insulating material 6, as in the case of FIG. 3.

Should the element 1 have a further and third dividing partition 5 interposed between the first and the second dividing partition 5 on the left and on the right respectively, the first and the second intermediate walls 5a, 5b of said third dividing partition 5 could each have a layer of thermal-insulating material 6 on the first and/or second face, or be devoid of additional layers.

The application of low-emissivity and thermal-insulating paints can include the execution of painting steps after the construction of the structural components of element 1. The application of paints can involve faces of the first side wall 2 and/or of the second side wall 3 and/or of the dividing partitions 5 in their entirety, or alternatively only portions of these faces.

In order to provide sufficient structural strength to the invention, each of the first and the second side walls 2a, 2b and of the first and the second intermediate walls 5a, 5b of the dividing partition 5 is made of cementitious material or more generally of any mortar having extrudability and/or 3D printability properties. In particular, said cementitious material comprises cement mortar.

In a preferred embodiment, the mortar comprises a cementitious composition which reproduces the teachings of the European patent EP3487673B1 in the name of the Applicant Etesias Srl, in particular the teachings referred to in paragraphs [0032] to [0045].

Profitably, the cement composition comprises:
cement, preferably between 15% and 30% by weight with respect to the total weight of the composition,
at least one inert aggregate, preferably between 60% and 80% by weight with respect to the total weight of the composition,
water, as much as necessary to reach 100% by weight of the composition.

The cementitious composition may also comprise further elements, in particular those in the following list:
at least one polymer-fiber additive preferably between 0.02% and 0.75% by weight with respect to the total weight of the composition,
at least one fluidifying agent, preferably between 0.03% and 0.1% by weight with respect to the total weight of the composition.
at least one viscosity modifying agent, preferably between 0.1% and 2.5% by weight with respect to the total weight of the composition.

More precisely, the weight ratio between water and cement is between 0.3 and 0.45 or the water/cement equivalent ratio is between 0.29 and 0.49; the expression cement equivalent means that part of the cement is replaced by type II additions according to the UNI EN 206-1:2006 standard in a percentage between 1% and 3% by weight with respect to the total weight of the composition.

In order to ensure surface homogeneity, the maximum diameter of the at least one inert aggregate is less than 13.5 mm, preferably less than 13 mm, more preferably less than 12.5 mm.

The Applicant observes that among the types of cement that can be used in the cementitious composition, the cement is preferably selected from a group of cements belonging to types I, II, III, IV, V, established by the EN 197-1 standard. This standard is implemented at a national level by the UNI EN 197/1 standard; preferably the cement is selected from those belonging to types I, II, III, IV and V and having resistance classes 42.5R and 52.5R according to the UNI EN 197/1 standard; more preferably, the cement is selected from those belonging to the CEM II/AL (or A-LL) 42.5R and CEM II/AL (or A-LL) 52.5R classes; even more preferably, the cement is selected from those belonging to the CEM II/AL (or A-LL) 42.5R class according to the UNI EN 197/1 standard. This ensures compliance with the standards and optimal resistance of the manufactured product.

When present, the inert aggregate is preferably selected from fine aggregates, fillers and mixtures thereof. The filler is selected from quartz sand, silica sand and limestone filler. The inert aggregate comprises a mixture of sand and quartz sand and/or limestone filler.

When present, the polymeric fiber preferably comprises at least one of: a polyolefin fiber, preferably polypropylene (PP); a polyvinyl alcohol (PVA) fiber; a polyester fiber; an aliphatic polyamide fiber (Nylon).

When present, the superplasticizing agent can be selected from optionally modified polymers polycarboxylic polyethers, naphthalenesulfonic, polyphosphonic, acrylic, propylene glycols and mixtures thereof. Preferably, the superplasticizing agent is a modified polycarboxylic polyether polymer.

In a further embodiment, the cement mortar comprises cement (by way of example and not as a limitation, Portland Clinker) and a stone aggregate, preferably fine-grained. This stone aggregate, in a non-limiting way, may include in particular sand and/or blast-furnace slag and/or shale and/or limestone and/or fly ash. Depending on the composition chosen, the cement mortar can comprise between about 3 kg of cement per dm³ of stone aggregate to about 6 kg per dm³ of stone aggregate.

In particular, it can therefore be asserted that, on the whole, the materials for making element 1 are the following:
(i) cement mortar suitable to meet the needs required by 3D printing technologies for extrusion;
(ii) low-emissivity material, in particular low-emissivity paint;
(iii) thermal-insulating material, in particular thermal-insulating paint.

In a preferred but non-limiting embodiment, the mortar is produced starting from a dry premixed powder consisting of selected sands with the addition of water. The compound (obtained by respecting appropriate proportions, in particular preferably those proposed above) has mechanical properties that are useful for self-supporting during a 3D printing step.

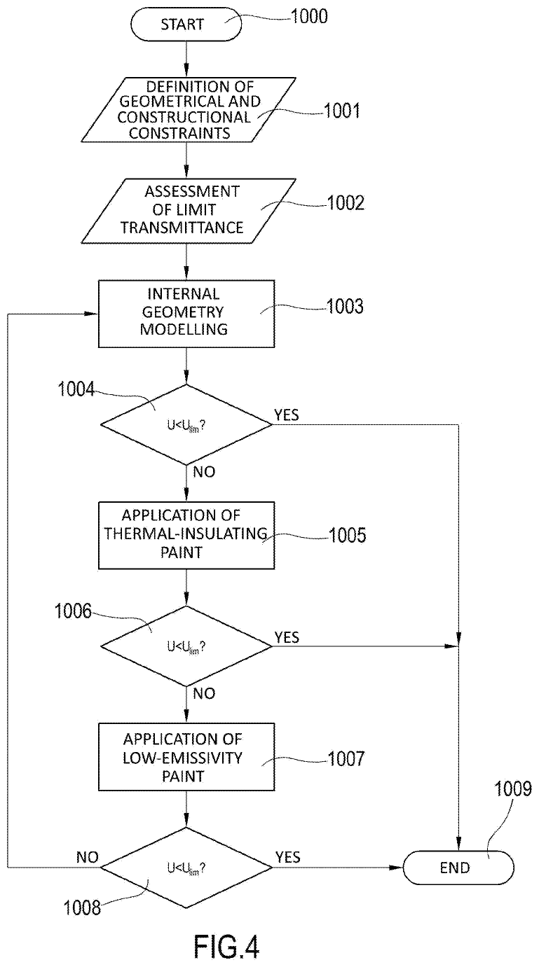

FIG. 4 illustrates a flowchart which allows defining part of a method of constructing structures by means of the element 1 described herein. The flowchart of FIG. 4 in detail relates to a method of manufacturing a self-supporting element for the construction of structures.

In an initial step (block 1000, FIG. 4), the method provides a step of defining the geometric and constructional constraints (block 1002, FIG. 4) for the structure under construction. The geometric and constructional constraints include, in a non-exhaustive list, the length, width and thickness of the element 1 and the print data of the various layers created by the first and the second side walls 2a, 2b, by the dividing partition 5, and in particular by the first and the second intermediate walls 5a, 5b, of the element 1; in particular, their distance, their thickness and the extrusion profile of the layers themselves or the possible maximum inclination of the element 1 are evaluated.

Account is also taken of a limit value Uₗᵢₘ of thermal transmittance U that the element 1 must have due to the constructional constraints and/or the environmental conditions of application. This limit value Uₗᵢₘ of thermal transmittance is a maximum limit value. The assessment of the thermal transmittance of element 1 corresponds to block 1002 of FIG. 4.

On the basis of the geometric and constructional constraints and on the basis of the limit value Uₗᵢₘ of thermal transmittance, the internal geometry (block 1003) is modelled.

Once the basic internal modelling has been defined, if the thermal transmittance U is lower than the limit value Uₗᵢₘ (block 1004, output Yes) there is no need to adopt further details on element 1; the process therefore ends (block 1009, FIG. 4).

Otherwise, if the thermal transmittance U is greater than Uₗᵢₘ (block 1004, output No), first of all an application (block 1005, FIG. 4) of the thermal-insulating material, in particular of the thermal-insulating paint, is carried out.

In detail, the thermal-insulating material can be applied on at least one between the first and the second side walls 2, 3, in particular on at least one external face 2e, 3e of at least one between the first and the second side walls 2, 3 and/or at least on the internal faces of the first and/or second wall 5a, 5b of the dividing partition.

With specific reference to the embodiment of the element 1 illustrated in FIG. 3, it can be observed that the thermal-insulating material is applied on the external face 2e of the first side wall 2, on the external face 3e of the second side wall 3, on the internal face of the first wall 5a of the dividing partition 5 on the left, on the internal face and on the external face of the second wall 5b of the dividing partition 5 on the left, on the internal face and on the external face of the first wall 5a of the dividing partition 5 on the right, and on the internal face of the second wall 5b of the dividing partition 5 on the right. By this application, the thermal insulation by conduction of the element 1 along the second axis Y is maximized.

At this point, the process includes a new check (block 1006, FIG. 4) of whether the thermal transmittance U is less than the limit value Uₗᵢₘ. If yes (block 1006, output Yes), there is no need to adopt further details on element 1; the process therefore ends (block 1009, FIG. 4). If not (block 1006, output No), an application (block 1007, FIG. 4) of the low-emissivity material, in particular of the low-emissivity paint, is carried out.

The application of the layer 7 of low-emissivity material takes place on at least one between the first and the second side walls 2, 3, and in particular on an internal face 2i, 3i of at least one between the first and the second side walls 2, 3. In the specific embodiment of FIG. 3, the layer 7 of low-emissivity material is present both on the internal face 2i of the first side wall 2, and on the internal face 3i of the second side wall 3, and is also present on the external face of the first intermediate wall 5a of the dividing partition 5 on the left and on the external face of the second intermediate wall 5b of the dividing partition 5 on the right.

Once the above application has been completed, a new check is carried out (block 1008, FIG. 4) of whether the thermal transmittance U is less than the limit value Uₗᵢₘ. If yes (block 1008, output Yes), there is no need to adopt further details on element 1; the process therefore ends (block 1009, FIG. 4). If not (block 1008, output No), a step of modelling the internal geometry of the element 1 is carried out, by way of example and not as a limitation, by adding a further dividing partition 5 juxtaposed to the previous one.

Preferably, but not limitedly, the low-emissivity paint and/or the thermal-insulating paint is applied by using an airbrush, or in any case, more generally, by using a spray technique.

It is noted, in particular, that before the installation of the element 1 it is preferable to wait for a predetermined time to allow the previously sprayed paint to dry. This drying time, preferably longer than ten minutes, is generally defined by the paint manufacturer, on the basis of the characteristics and/or composition and/or according to the characteristics (at least porosity and/or type) of the material on which said paint is sprayed.

In any case, it is noted that before proceeding with the spraying of the paint on the cement mortar it is preferable to wait a predetermined time for said cement mortar to reach a predetermined level of drying.

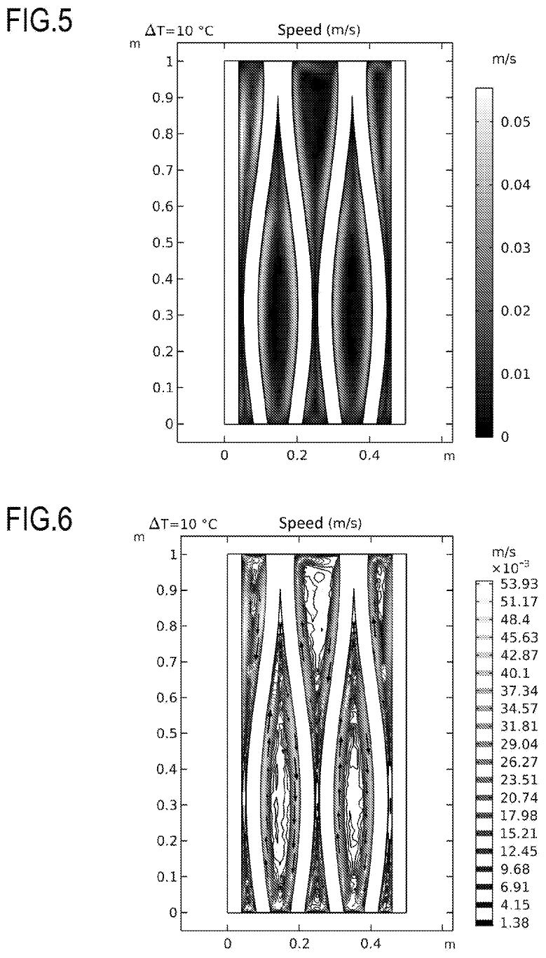

As can be seen in the diagram of FIG. 5 and FIG. 6, through the use of the particular curved and doubled and/or split conformation for the dividing partition 5 of the element 1 it is possible to significantly reduce the speed of the air flow in the air volume 4 present between the first and the second side walls 2, 3. As can be seen in FIG. 5, the air flow is substantially close to 0.01 m/s in most portions of the air volume 4 when a temperature differential ΔT=10° C. is present between the upper portion and the lower portion of the element 1. Only the portions of air volume 4 close to the internal face 2i of the first wall 2 and to the internal face 3i of the second wall 3 near the upper end portion of each dividing partition 5 are characterized by a substantially higher air velocity, in the order of 0.05 m/s or more. It is therefore observed that the thermal convection is significantly reduced due to the reduced speed assumed by the air inside the air volume 4.

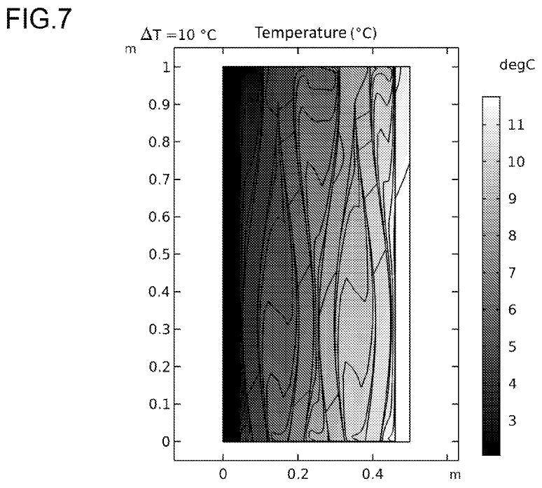

As illustrated in FIG. 7, it can be observed that the element 1 described herein achieves a significant reduction in thermal transmittance when subjected to temperature differentials along the second axis Y. In particular, FIG. 7 illustrates a measurement configuration wherein a differential of temperature ΔT=10° C. is present along the second axis Y between the first side wall 2 and the second side wall 3; the areas represented with darker color are colder. As the color tends to white, the temperature becomes higher.

The simulations performed then revealed that the thermal flux [W/m²] established within element 1 with a temperature differential ΔT=10° C. along the first axis X has an average value substantially equal to (or less than) 3.35 W/m². This is a significantly lower thermal flux value than the one that would be obtained with reference structures without internal cavities, showing a high efficiency of the element 1 according to the invention in reducing thermal transmission.

The prototyping of the 3D model of element 1 is done using CAD software. The geometry thus created is imported into a software for thermo-fluid dynamics simulation (CFD), through which the thermal performance of element 1 is evaluated by defining appropriate boundary conditions.

An experimental evaluation was carried out in the thermal analysis laboratory of insulating materials (IMATlab) of the Federico II University of Naples, using the NETZSCH Guarded Hot Plate (GHP) 456 Titan® instrumentation, through which a thermal conductivity value of the material (k) of 1.05 W/mK was obtained.

The non-limiting prototype of the element 1 examined during the experimental evaluation involves the application of two low-emissivity paint layers for the mitigation of thermal radiation phenomena. In detail, this paint guarantees a reduction in the emissivity of the cavity walls with consequent reduction of the thermal power transferred by radiation.

Low-emissivity paints capable of ensuring an emissivity value of 0.2 in the infrared band are currently on the market.

Since the thermal power released by a surface is proportional to its emissivity, the adoption of these paints (based on aluminum powders) by virtue of the reduced emissivity leads to a reduction of the overall thermal radiation emitted by the element 1.

The geometry optimization step is preparatory to the construction of the prototype. In detail, the optimization process consists in parameterizing the model according to the geometric constraints set during the design step. Each geometric variable can assume discrete values within a suitably defined range in relation to the identified geometric constraints.

The main geometric variables that influence the objective function to be minimized, represented by the thermal transmittance U, are the overall thickness along the second axis Y of the element 1 and the thickness of each of the layers of cement mortar making up the first and the second side walls 2, 3 and the first and second side walls 5a, 5b of each of the dividing partitions 5 present in the element 1.

It has been experimentally verified how the stability of the cement mortar in the deposition step is influenced by this parameter. In detail, the greatest stability is achieved if a 0.04 m diameter nozzle is used to carry out the aforementioned 3D printing. In general, optimal diameters for the 3D printing of said cement mortar are substantially between 0.03 m and 0.05 m, more preferably between 0.035 m and 0.045 m.

In a preferred and non-limiting embodiment, the maximum extension along the first axis X and along the third axis Z of the element 1 is 3 m; along the second axis Y, said maximum extension is preferably equal to 0.6 m. Although there are no theoretical limits of the minimum extension of the element 1 along the first axis X and along the third axis Z, in one embodiment the minimum extension of the element 1 along the second axis Y is 0.4 m. Preferably, but not limitedly, the maximum overhang is equal to 15°. Furthermore, in a non-limiting embodiment, each of the walls made of cementitious material has a thickness, measured along the second axis Y, substantially comprised between 4 and 6 cm.

### Advantages of the Invention

The advantages of the element 1, object of the present disclosure, are clear in the light of the preceding description. Said element 1 is designed to optimize the energy efficiency of structures, in particular residential buildings, and is simply and economically made by means of 3D printing. The element 1 adopts a particular structural conformation which simultaneously optimizes a reduction in thermal conduction, thermal convection and thermal radiation. The element 1 can also be economically produced on a large scale and can be adapted through the use of low-emissivity and thermal-insulating paints to different regulations in relation to the climatic context of the structure. In particular, the reduction of conduction, convection and radiation is achieved by means of a high-strength element 1.

The element 1 described herein is also compatible to be placed side by side, optionally juxtaposed, to at least one other element 1, or to more than one element 1, along the direction indicated by the axis Y to further reduce thermal transmission.

The invention is not limited to the embodiments illustrated in the Figures. For this reason, the reference signs in the claims should not be understood in a limiting way. In fact, the reference signs are provided for the sole purpose of increasing the intelligibility of the claims.

Finally, it is clear that additions, modifications or variants, which are obvious to a person skilled in the art, may be applied to the element and method described herein, without thereby falling outside the scope of protection provided by the appended claims.

1.-155. (canceled)

156. A self-supporting element for construction of structures comprising:
a first panel made of a 3D extrudable or printable mortar;
a second panel made of a 3D extrudable or printable mortar, wherein the first panel and the second panel are lying on planes substantially parallel to each other and being arranged according to a predetermined positional relationship so that a separation volume is defined between the first panel and the second panel; and
at least one dividing partition made of a 3D extrudable or printable mortar, wherein the at least one dividing partition is housed in the separation volume such that, taking a first point, a second point, and an imaginary straight line, the first point belonging to the first panel, the second point belonging to the second panel, and the imaginary straight line joining the first point and the second point, results in the imaginary straight line intersecting the at least one dividing partition.

157. The element of claim 156, wherein the first panel is made of a cement mortar or is made with at least one binder alternative to cement, the at least one binder alternative to cement being a natural, recycled, or lightweight binder, wherein the second panel is made of the cement mortar or is made with the at least one binder alternative to cement, and wherein the at least one dividing partition is made of the cement mortar or is made with the at least one binder alternative to cement.

158. The element of claim 156, wherein (i) a portion of the at least one dividing partition is in a condition of contact or contiguity with the first panel or with the second panel and (ii) a remainder of the at least one dividing partition is separated from the first panel and from the second panel, and wherein the portion is less than 15% of a dimension of the at least one dividing partition, the dimension being measured along a direction parallel to a direction along which the first panel or the second panel extend.

159. The element of claim 156, wherein the at least one dividing partition has a curved profile or a sinusoidal profile.

160. The element of claim 156, wherein the at least one dividing partition comprises a first wall and a second wall, and wherein the first wall and the second wall are configured so as to define a cavity within the at least one dividing partition.

161. The element of claim 156, wherein at least one of the first panel and the second panel is at least partially covered with a layer of thermal-insulating material, the layer of thermal-insulating material being configured to mitigate transmission of heat by conduction, being positioned on a face of the at least one of the first panel and the second panel, and facing outwards, the layer of thermal-insulating material being a layer of thermal-insulating paint, wherein the thermal-insulating paint comprises a glassy material, glass microspheres, or hollow glass microspheres.

162. The element of claim 156, wherein at least one of the first panel, the second panel, and the at least one dividing partition is at least partially coated with a layer of low-emissivity material, the layer of low-emissivity material being configured to mitigate transmission of heat by radiation, being positioned on a face of the at least one of the first panel and the second panel, and facing inwards or being positioned on a face of the at least one dividing partition facing the first panel or the second panel, the layer of low-emissivity material being a layer of low-emissivity paint, wherein the low-emissivity paint comprises aluminum powders.

163. The element of claim 156, wherein the at least one dividing partition comprises a first portion and a second portion, and has first and second intermediate walls, the first intermediate wall being joined to the second intermediate wall in correspondence of the first portion and being separated from the second intermediate wall at least in correspondence of the second portion, and wherein between the first and the second intermediate wall an air volume is present, the air volume being defined by the first portion, wherein the first and the second intermediate wall each comprise a first and a second face, wherein at least one of the first face and the second face of the first and of the second intermediate walls is coated with a layer of low-emissivity material, wherein the low-emissivity material is a low-emissivity paint configured to mitigate a transmission of heat.

164. The element of claim 156, wherein the element has a substantially symmetrical conformation with respect to an imaginary plane parallel to the first panel and to the second panel, and wherein the element has a thickness ranging between 35 cm and 65 cm, and wherein the element is configured to have a thermal conductance substantially equal to or less than 0.48 W/m2K.

165. The element of claim 156, wherein the 3D extrudable or printable mortar comprises at least one polymer-fiber additive, at least one viscosity modifying agent, or at least one superplasticizing agent, and wherein the at least one polymer-fiber additive ranges between 0.02% and 0.75% by weight with respect to a total weight of the 3D extrudable or printable mortar, the at least one viscosity modifying agent ranges between 0.1% and 2.5% by weight with respect to the total weight of the 3D extrudable or printable mortar, or the at least one superplasticizing agent ranges between 0.03% and 0.1% by weight with respect to the total weight of the 3D extrudable or printable mortar.

166. A method of manufacturing a self-supporting element for construction of structures, the element comprising a first panel made of a 3D extrudable or printable mortar, a second panel made of the 3D extrudable or printable mortar, and at least one dividing partition made of the 3D extrudable or printable mortar, wherein the first panel and the second panel are positioned on planes substantially parallel to each other and are arranged according to a predetermined positional relationship so that a separation volume is defined between the first panel and the second panel, wherein the at least one dividing partition is housed in the separation volume such that, taking a first point, a second point and an imaginary straight line, the first point belonging to the first panel, the second point belonging to the second panel, and the imaginary straight line joining the first point and the second point, results in the imaginary straight line intersecting the at least one dividing partition, the method comprising:
3D extruding or printing the at least one dividing partition from the 3D extrudable or printable mortar.

167. The method of claim 166 further comprising:
3D extruding or printing the first panel from the 3D extrudable or printable mortar; and
3D extruding or printing the second panel from the 3D extrudable or printable mortar.

168. The method of claim 167 further comprising:
depositing a layer of the first panel;
depositing a layer of the at least one dividing partition; and
depositing a layer of the second panel.

169. The method of claim 166 further comprising:
defining a cavity within the at least one dividing partition; and
forming at least a part of the at least one dividing partition into profiles that are mirror images to each other.

170. The method of claim 166 further comprising:
defining a threshold of thermal transmittance of the element;
measuring the thermal transmittance of the element;
in response to the thermal transmittance of the element being greater than the threshold,
applying a layer of thermal-insulating material on at least a part of one of the first panel and the second panel, the thermal-insulating material being configured to mitigate transmission of heat by conduction,
applying of a layer of low-emissivity material on at least the part of one of the first panel and of the second panel or on at least a part of the dividing partition, the low-emissivity material being configured to mitigate transmission of heat by radiation, or
arranging a second dividing partition between the first panel and the at least one dividing partition or between the second panel and the at least one dividing partition.

171. The method according to claim 166, wherein the 3D extrudable or printable mortar is cement mortar comprising cement and stone aggregate, the mortar comprising (i) cement mixed with stone aggregate in proportions ranging between 3 kg of cement per dm³ of stone aggregate and 6 kg of cement per dm³ of stone aggregate, or (ii) mortar including binders to cement wherein the binders comprise at least one natural, recycled, or lightweight binder.

172. The method of claim 166, wherein the 3D extrudable or printable mortar comprises:
cement ranging 15% and 30% by weight with respect to a total weight of the mortar;
at least one inert aggregate or at least one stone aggregate ranging between 60% and 80% by weight with respect to the total weight of the mortar, wherein the maximum diameter of the at least one inert aggregate is less than 15 mm;
water, wherein a weight ratio of water to cement ranges between 0.3 and 0.45, or a water to cement equivalent ratio ranges between 0.29 and 0.49, wherein cement equivalent corresponds to a part of the cement that is replaced with type II additions according to UNI EN 206-1:2006 standards in a percentage ranging between 1% and 3% by weight with respect to the total weight of the mortar; and
(i) a polymeric fiber additive, ranging between 0.02% and 0.75% by weight with respect to the total weight of the mortar, (ii) a plasticizing agent, ranging between 0.03% and 0.1% by weight with respect to the total weight of the mortar, or (iii) a viscosity modifying agent, ranging between 0.1% and 2.5% by weight with respect to the total weight of the mortar.

173. The method of claim 172, wherein the at least one inert aggregate is selected from fine aggregates, fillers and mixtures thereof, the filler being in particular selected from quartz sand, silica sand and calcareous filler, wherein the polymeric fiber comprises at least one of a polyolefin fiber, a polypropylene, a polyvinyl alcohol fiber, a polyester fiber, an aliphatic polyamide fiber, and wherein the plasticizing agent is a superplasticizing agent selected from modified polymers, polycarboxylic polyethers, naphthalenesulfonic, polyphosphonic, acrylic, propylene glycols and mixtures thereof.

174. An architectural structure comprising:
at least one wall, the wall comprising a plurality of self-supporting elements or being covered with a coating comprising a plurality of self-supporting elements, wherein the self-supporting elements comprise:
a first panel made of 3D extrudable or printable mortar,
a second panel made of the 3D extrudable or printable mortar, wherein the first panel and the second panel are positioned on planes substantially parallel to each other and are arranged according to a predetermined positional relationship so that a separation volume is defined between the first panel and the second panel, and
at least one dividing partition made of 3D extrudable or printable mortar, wherein the at least one dividing partition is housed in the separation volume such that, taking a first point, a second point, and an imaginary straight line, the first point belonging to the first panel, the second point belonging to the second panel, and the imaginary straight line joining the first point and the second point, the imaginary line intersects the at least one dividing partition.

175. The architectural structure of claim 174, wherein a part of the at least one dividing partition comprises a first wall and a second wall, the first wall and the second wall being configured so as to define a cavity within the at least one dividing partition, wherein the first wall and the second wall have profiles which are mirror image of each other or have sinusoidal profiles.
